(19) United States
(12) Patent Application Publication
(10) Pub. No.: US 2011/0146042 A1
(43) Pub. Date: Jun. 23, 2011

(54) CAPACITOR METHOD OF FABRICATION

(76) Inventors: David Allan Kelly, Calgary (CA); Donna Lee Kelly, Calgary (CA)

(21) Appl. No.: 12/919,727

(22) PCT Filed: Sep. 11, 2009
(86) PCT No.: PCT/CA2009/001263

§ 371 Date: Aug. 26, 2010

Related U.S. Application Data
(60) Provisional application No. 61/096,531, filed on Sep. 12, 2008.

(30) Foreign Application Priority Data
Sep. 15, 2008 (CA) 2,639,524

(51) Int. Cl. H01G 7/00

(52) U.S. Cl. 29/25.41

(57) ABSTRACT

A method of manufacture of a polymer or ceramic polymer capacitor, of various sizes and voltage ratings. The fabrication equipment deposits a polymer or ceramic polymer dielectric layer on a carrier substrate with the electrode structure of the capacitor previously deposited on its surface. The sheet is often then fabricated into a capacitor by rolling into an axial style or the sheet is cut and stacked into a rectangular type. An alternate arrangement of the fabrication process has additional electrode layers deposited alternating with dielectric layers in continuous process until the desired number of layers is achieved. At that point the sheet is cut to form capacitors of a rectangular form.

### FIELD OF THE INVENTION

The field of the invention relates a self-healing capacitor manufacturing process using polymer or ceramic polymer as its dielectric.

### BACKGROUND OF THE INVENTION

Many new polymer and ceramic polymer dielectrics have been developed that offer the advantage of being lower cost or higher in energy density than that used for the fabrication of current capacitors. A large number of these materials are not compatible with current volume manufacturing processes used to fabricate capacitors.

Polymers are only used if they can be fabricated into polymer films that have adequate tensile strength for the manufacture of thin continuous sheets. These sheets are typically less than 25 microns in thickness and fabricated into capacitors using electrodes consisting of a metalized film or foil. If a newly developed polymer is to be fabricated into capacitor samples using current fabrication techniques it must be fabricated into a continuous sheet, which is both expensive and requires large quantities of polymer. The whole process is so expensive that very few of the newly developed polymers, with promising dielectric properties are ever fabricated into bulk samples. Polymers that have low tensile strength are often completely ignored by commercial manufacturers, as there is no method to economically fabricate the material into a capacitor.

Current manufacturing methods for ceramic polymer dielectrics involve their fabrication into layers sandwiched between layers of copper foil which are then used in circuit boards as embedded capacitor layers. The embedded capacitors lack the capability of self-healing and are not optimized for energy storage. There is no low cost method to fabricate a self-healing capacitor that uses a ceramic polymer as its dielectric. Further, the current method of fabrication of ceramic polymer capacitors does not facilitate the orientation of the ceramic crystals within the polymer matrix using the ‘Winslow Effect’ between the capacitor electrodes as explained in Canadian patent application CA 2,598,754. This results in a capacitor with a dielectric constant that is typically 1/100^{th} that of the ceramic dielectric powder that is used in its fabrication.

One of the most serious problems that affect current ceramic-polymer capacitors construction is the lack of self-healing. The U.S. Pat. No. 6,265,058 represents a novel method for the fabrication of the ceramic polymer into laminated sheets for use as an embedded capacitor layer in circuit boards. The ceramic polymer material is sandwiched between two layers of copper foil. A short circuit in the ceramic polymer dielectric would result in a permanent short circuit across the embedded capacitor, destroying the circuit board. In order to avoid such failures the working voltage of the ceramic-polymer layer is kept very low when compared to that of a capacitor that is self-healing made from metalized film. The inefficient use of the ceramic-polymer dielectric layer makes the capacitor design not an economic choice for the manufacture of capacitors for another application other than as an embedded layer in a circuit board.

Another problem with current ceramic polymer capacitor technology, represented by Canadian patent application number CA 2,598,754, is that the self-healing electrode is part of a carrier substrate often 8 microns thick or greater. The substrate layer, with the integrated self-healing electrodes is alternated with the ceramic polymer dielectric increasing the capacitor cost and thickness in some designs by over 2 times. Ideally a method is required for applying self-healing electrodes to the ceramic polymer layer without the added cost and thickness of the carrier substrate of current design. The elimination of this layer will in some designs double the energy density of the capacitor and reduce the manufacturing cost by up to 50%.

Another serious problem with current ceramic polymer capacitor design has to do with the cost and ease of increasing the volume of production. As capacitor energy density steadily increases a point will be reached where they are competitive against storage batteries in a number of very large volume applications. The first such anticipated application of these ultra capacitors will be in electric hybrid vehicles and electric grid storage. When the transition happens the volume of capacitors will not just double but increase by over 1,000. As the volume of production dramatically increases a method of mass-producing large volumes of capacitors in a fully automated process becomes the only practical method of manufacture. An example of the current fabrication process is represented by U.S. Pat. No. 6,265,058 where in the capacitor film is first manufactured, then put through a totally separate process for fabrication of the electrodes. After these two separate processes the metalized film is fabricated into capacitors. Each operation is expensive and involves the handling of the film with risk of contamination. Scaling such a process to very large levels of manufacturing is very expensive. Ideally what is needed for these volumes is a new method of capacitor fabrication that takes in all the raw materials and produces as its output finished capacitors.

### SUMMARY OF THE INVENTION

The invention is an improved method of capacitor fabrication. In one aspect of the invention a roll of polymer film, with an electrical electrode structure deposited on its surface, is passed through a controlled deposition process where an electrically conductive polymer mixture is deposited on the portions of the electrode structures that are not dielectrically active and exit the capacitor structure to facilitate the making of an external electrical connection to the inner portion of the electrode. The deposited electrically conductive mixture is allowed to adequately dry before a dielectric layer is deposited on the surface of the polymer sheet by a controlled process. The continuous polymer sheet is then dried, using a controlled temperature, to remove any solvent that was added as an aid to facilitate the deposition process used for the electrically conductive polymer mixture or dielectric material. The polymer sheet is then continuously slit into strips to fit the inner portion of a bobbin, which the strips are continuously wound upon, to a predetermined diameter, to form an axial style of capacitor. The capacitor is then subjected to a controlled and combined temperature, pressure and electrical bias profile to complete the curing of the polymer and dielectric enhancement of the capacitor. Electrical terminations of a predefined type are added and the capacitor tested.

In another aspect of the invention a roll of polymer film, with an electrical electrode structure deposited on its surface, is passed through a controlled deposition process where an electrically conductive polymer mixture is deposited on the portions of the electrode structures that are not dielectrically active and exit the capacitor structure to facilitate the making of an external electrical connection to the inner portion of the electrode. The deposited electrically conductive mixture is allowed to adequately dry before a dielectric layer is deposited on the surface of the polymer sheet by a controlled process. The polymer sheet is then dried, using a controlled temperature, to remove any solvent that was added as an aid to facilitate the deposition process used for the electrically conductive polymer mixture or dielectric material. The continuous polymer sheet is then cut into individual sheets that are then stacked on top of each other in a controlled manner. The capacitor is then subjected to a controlled and combined temperature, pressure and electrical bias profile to complete the curing of the polymer and dielectric enhancement of the capacitor. The capacitors are then separated from the sheets and electrical terminations of a predefined type are added and the capacitor tested.

In a preferred embodiment of the invention a continuous sheet roll of polymer is continuously fed to a controlled deposition process wherein an electrically conductive polymer mixture is deposited on portions of the electrode structures that are not dielectrically active and where they exit the capacitor structure to facilitate the making of an external electrical connection to the inner portion of the electrode. The deposited electrically conductive mixture is allowed to adequately dry before a dielectric layer is deposited on the surface of the electrode structure by a controlled process. The continuous polymer sheet is then dried, using a controlled temperature, to remove any solvent that was added as an aid to facilitate the deposition process used for the electrically conductive polymer mixture or dielectric material. An electrode structure is then transferred from a polymer sheet onto the newly deposited dielectric surface. The process of depositing an electrically conductive polymer mixture, followed by a dielectric layer then by an electrode structure is repeated until a predetermined number of layers have been deposited. The polymer sheet is then continuously slit into strips to fit the inner portion of a bobbin, which the strips are continuously wound upon, to a predetermined diameter, to form an axial style of capacitor. The capacitor is then subjected to a controlled and combined temperature, pressure and electrical bias profile to complete the curing of the polymer and dielectric enhancement of the capacitor. Electrical terminations of a predefined type are added and the capacitor tested.

In a second preferred embodiment of the invention a continuous sheet roll of polymer is continuously fed to a controlled deposition process wherein an electrically conductive polymer mixture is deposited on portions of the electrode structures that are not dielectrically active and where they exit the capacitor structure to facilitate the making of an external electrical connection to the inner portion of the electrode. The deposited electrically conductive mixture is allowed to adequately dry before a dielectric layer is deposited on the surface of the electrode structure by a controlled process. The polymer sheet is then dried, using a controlled temperature, to remove any solvent that was added as an aid to facilitate the deposition process used for the electrically conductive polymer mixture or dielectric material. An electrode structure is then transferred from a polymer sheet onto the newly deposited dielectric surface. The process of depositing an electrically conductive polymer mixture, followed by a dielectric layer then by an electrode structure is repeated until a predetermined number of layers have been deposited. Then a protective, electrically insulating layer is placed on top of the capacitor structure. The polymer sheet is then cut into individual sheets that are then stacked on top of each other in a controlled manner. The capacitor is then subjected to a controlled and combined temperature, pressure and electrical bias profile to complete the curing of the polymer and dielectric enhancement of the capacitor. The capacitors are then separated from the sheets and electrical terminations of a predefined type are added and the capacitor tested.

In another embodiment of the invention a sheet of polymer is wound on the outside of a rotary wheel, to a predetermined thickness, to form a substrate for the fabrication of capacitors. Upon the substrate various capacitor structures are deposited. Whereupon, through a controlled deposition process, an electrically conductive polymer mixture is deposited on portions of the electrode structures that are not dielectrically active and where they exit the capacitor structure to facilitate the making of an external electrical connection to the inner portion of the electrode. The deposited electrically conductive mixture is allowed to adequately dry before a dielectric layer is deposited on the surface of the electrode structure by a controlled process. The polymer sheet is then dried, using a controlled temperature, to remove any solvent that was added as an aid to facilitate the deposition process used for the electrically conductive polymer mixture or dielectric material. An electrode structure is then transferred from a polymer sheet onto the newly deposited dielectric surface. The process of depositing an electrically conductive polymer mixture, followed by a dielectric layer then by an electrode structure is repeated by the controlled rotation of the wheel until a predetermined number of layers have been deposited. Then a protective, electrically insulating layer is placed on top of the capacitor structure. The cylindrical structure is removed from the wheel and cut into individual sheets, which are often stacked on top of each other in a controlled manner, or cut into separate capacitors. The stacked sheets or individual capacitors are then subjected to a controlled and combined temperature, pressure and electrical bias profile to complete the curing of the polymer and dielectric enhancement of the capacitor. The capacitors are then separated from the sheets and electrical terminations of a predefined type are added and the capacitor tested.

In a further embodiment of the invention a sheet often made from, but not limited to polymer is cut to a predetermined size to form a substrate for the fabrication of capacitors. Upon the substrate various capacitor structures are to be deposited. The sheet is passed through a controlled deposition process wherein an electrically conductive polymer mixture is deposited on portions of the electrode structures that are not dielectrically active and where they exit the capacitor structure to facilitate the making of an external electrical connection to the inner portion of the electrode. The deposited electrically conductive mixture is allowed to adequately dry before a dielectric layer is deposited on the surface of the electrode structure by a controlled process. The polymer sheet is then dried, using a controlled temperature, to remove any solvent that was added as an aid to facilitate the deposition process used for the electrically conductive polymer mixture or dielectric material. An electrode structure is then deposited through a controlled process onto the newly deposited dielectric surface. The process of depositing an electrically conductive polymer mixture, followed by a dielectric layer then by an electrode structure is repeated by the controlled forward and backward movement of the substrate past the deposition area until a predetermined number of layers have been deposited. Then a protective, electrically insulating layer is placed on top of the capacitor structure. The sheet of individual capacitors is then subjected to a controlled and combined temperature, pressure and electrical bias profile to complete the curing of the polymer and dielectric enhancement of the capacitor. The capacitors are then separated from the sheets and electrical terminations of a predefined type are added and the capacitor tested.

In most but not all embodiments, the capacitors are deposited in a manner such they are often physically separate from each other; except for the common substrate they are formed upon and often but not always a shared electrical connection.

The embodiments of the invention use often, but not limited to, a controlled deposition process comprising one or more of silk screen printing, transfer printing, offset printing, industrial jet printing, spraying.

In embodiments of the invention the electrode structure is deposited on top of the dielectric layer using an electrically conductive polymer mixture in a controlled manner rather than transferred from a polymer sheet.

In embodiments of the invention the electrode material may be made from a corrosion resistant material such as, but not limited to, nickel, gold, tin, manganese oxide.

In embodiments of the invention, but not all, the electrode construction is made from a metal layer 10s of angstroms thick with electrical resistance from 10 to 1,000 ohms per square that, when subjected to the energy of a short circuit in a dielectric layer, converts, in the area of the short circuit, into an electrically insulating material, disconnecting the shorted area of dielectric from the rest of the capacitor.

In most but not all embodiments, the deposited electrode structure is composed of an electrically conducting material that, when subjected to the energy of a short circuit in a dielectric layer, converts, in the area of the short circuit, into an electrically insulating material, disconnecting the shorted area of dielectric from the rest of the capacitor.

In yet other embodiments a number of individual rectangular capacitors are assembled into a stack to form a larger rectangular capacitor. Often spaces or thermally conductive material is placed between the capacitors to aid in the cooling of inner layers. Alternately, the spaces are left between capacitors to accommodate the mechanical expansion or contraction of the dielectric layers.

In yet further embodiments the finished product is not used as a capacitor but as a sonic transducer for the generation of acoustic vibrations.

In other embodiments the finished product is not used as a capacitor but as an electrical energy to mechanical actuator for the physical movement of objects.

In most embodiments, but not all, the invention can be used for the fabrication of capacitors made of, but not limited to dielectrics composed of ceramic, glass or ceramic-glass.

In all embodiments the capacitor structure is often fabricated on another material other than a polymer sheet such as but not limited to paper.

A number of embodiments of the invention may be used for the fabrication of embedded capacitors in circuit boards and other electronic devices such as microprocessors, line filters etc.

Other advantages and novel features, objects, and further scope of applicability of the present invention will be set forth in part in the detailed description that follows, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

FIG. 1. Current method of ceramic polymer capacitor manufacture.

FIG. 2. Cross section of current ceramic polymer capacitors.

FIG. 3. Cross section of a preferred embodiment.

FIG. 4. Cross section of capacitor electrode structures used by a preferred embodiment.

FIG. 5. Another cross section of capacitor electrode structures used by a preferred embodiment.

FIG. 6. Axial capacitor bobbin of the preferred embodiment.

FIG. 7. A block diagram of the preferred embodiment of the invention.

FIG. 8. A sheet of capacitors manufactured by the preferred embodiment.

FIG. 9. Cross section of a capacitor manufactured by the preferred embodiment.

FIG. 10. An assembly of rectangular capacitors manufactured by the preferred embodiment.

FIG. 11. Another embodiment of the invention.

FIG. 12. Expanded view of the electrode transfer of the preferred embodiment.

FIG. 13. An example array of printing jets used by the preferred embodiment.

FIG. 14A Self-healing property of a capacitor made using an embodiment.

FIG. 14B Electrical behavior of a metalized film capacitor NOT made using an embodiment.

FIG. 14C Unique electrical behavior of a capacitor made using an embodiment.

### DETAILED DESCRIPTION OF THE INVENTION

The present invention is manufacturing equipment used to manufacture capacitors using a dielectric composed of a polymer or ceramic polymer. The manufacturing equipment may be modified for the construction of axial or rectangular style capacitors of various sizes, voltages and energy density. The manufacturing process may be fully automated and capacitors can be made from start to finish without intermediate steps. The manufacturing equipment is compatible with a large number of dielectric materials that are difficult or impossible to make into capacitors using current fabrication processes.

The invention is best understood by first looking at prior methods of fabrication such as that represented by the U.S. Pat. No. 5,504,993. FIG. 1 is a schematic representation of fabrications techniques with components such as enclosures omitted for purposes of clarity. Often the portion of the fabrication machine from 101 through to 105 are enclosed in an environment which may be an inert gas to prevent risk of fire or contamination of the deposited layers. Referring to FIG. 1, referred to as prior art, the current method of fabricating ceramic polymer capacitors starts with a roll of copper foil or polymer film 100 fed into a machine at 101 as a substrate. At 102 a ceramic polymer mixture with additives to modify the liquid properties are applied by one of many techniques such as Doctor Blade (often used for making green ceramic tapes), industrial inkjet printing, spraying, transfer roller etc. The method of application used is in relation to the required thickness and qualities of the final ceramic polymer layer. A Doctor Blade is often used for layers of less than 100 microns. Spraying is used for applications where high quality void free layers are not required or a later process removes voids to an acceptable level. Industrial inkjet or other offset printing equipment is used only when patterns are required or the ceramic polymer liquid being applied can be modified to be compatible with them. The ceramic polymer layer deposited on the substrate 103, continues to move through the machine to 104 where heat is applied to first drive out any volatiles from the ceramic polymer layer, such as solvents added to reduce the viscosity of the liquid for the deposition process. After the solvent is sufficiently removed, the later stages of 104 often applies pressure using rollers, not shown and raises the temperature further to cure the ceramic polymer. Other means of curing such as exposure to Ultra Violet radiation is used to complete curing when an UV sensitive catalyst is used. After leaving the evaporation and curing section the ceramic polymer is often rolled into a roll at 105 for use at a later stage of manufacture. Other fabrication processes may remove the ceramic polymer layer from the substrate and the substrate is rolled back in to a roll at 105 for reuse. The stripped ceramic polymer often is cut into sheets and fed into a machine for the manufacture of a capacitive layer in a circuit board. The process is automated for the manufacture of cured ceramic polymer sheets for use in a later manufacturing process. When copper foil is used as the substrate a top copper foil layer is applied before curing and after fabrication finishes is cut into suitably sized sheets for use as an embedded capacitor layer in circuit boards.

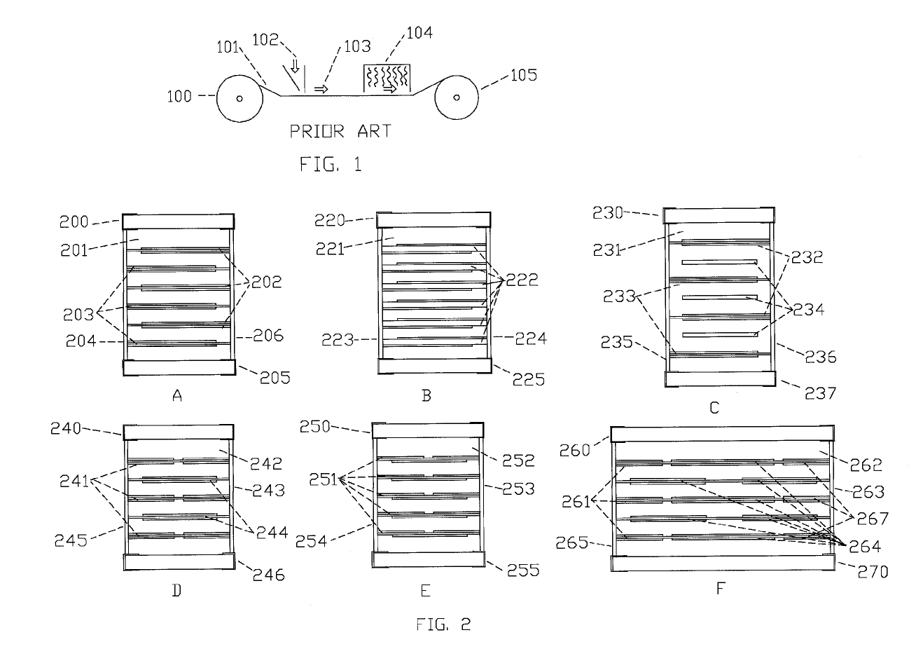

The explanation of FIG. 2 through 5 provides a detailed explanation of a number of capacitor cross sections that can be manufactured by different embodiments of the invention. The dielectric used in all embodiments of the invention is often but not limited to a ceramic polymer. However, all embodiments of the invention can use a dielectric composed of a single polymer, a blend of polymers or a polymer solid combination wherein the later the solid material is not a ceramic, such as, but not limited to quartz, a glass, tantalum oxide and titanium dioxide. The common requirement that all embodiments share is that the viscosity of the dielectric can be made compatible with the deposition process used to fabricate the capacitor. All FIGS. 2A, B, C, D, E and F use the preferred embodiment ceramic polymer dielectric and fabrication steps for assembly of the finished capacitor structure. FIG. 2A is formed by applying a layer of ceramic polymer to the topside of a variation of FIG. 5, where the electrodes are the same on each side of the carrier film rather than shifted as represented by FIG. 5 references 521 and 525. They are placed in alternating layers such that the right electrodes of one polarity are separated by at least one ceramic polymer layer from the left polarity electrodes, which form the other half of the capacitor. Reference 200 and 205 are the substrates for the capacitor, which are often ceramic if a hard durable material is required for a printed circuit board surface mount capacitor. Item 203 are the left electrodes, 202 the right ones and 201 the ceramic polymer dielectric that fills the remaining volume of the capacitor structure. The end electrical connections 204 and 206 make electrical contact to each of the electrical electrodes 203 and 202 respectively; formed by any of the methods commonly used in the manufacture of polymer film capacitors. To make the structure failure resistant electrodes 203 and 202 are 1 to 1000 ohms per square often a few 10s angstroms of aluminum.

FIG. 2B is similar to A except only one carrier film is used with the left and right electrically conductive electrode on opposite sides providing a simpler design where the ceramic polymer is often applied as a layer to one side and the layers then are stacked together until the desired capacitance value is achieved. Though FIG. 2B is simpler in construction the carrier substrate has to withstand the full working voltage of the capacitor, which is not a requirement in FIG. 2A. This is not a problem for low voltage capacitors but becomes less economical for high voltage capacitors, which preferably use FIG. 2A, C, D or F for lower cost and the smallest size. In FIG. 2 B, 220 and 225 are the end substrates, 221 the ceramic polymer, 222 the carrier film with opposite polarity electrodes, 223 and 224 are the end electrical connections made using any compatible process used by the manufacture of polymer film capacitors. To make the structure failure resistant, electrodes on the carrier film reference 222 is often 1 to 1000 ohms per square a few 10s angstroms of aluminum or other suitable alloy.

FIG. 2C is a structure that requires more process steps but has the highest impulse current capability of any design, still having a degree of failure resistance. Alternating the two different electrode carrier films, shown in 2C, with a dielectric layer on top assembles the capacitor. The first electrode 232 is formed by applying at least one ceramic polymer layer followed by the application of an externally isolated floating electrode 234 of 1 to 1000 ohms per square material that forms an electrically insulating material if it is involved in a dielectric short circuit between capacitor layers. Different processes often form the isolated electrode, such as but not limited to inkjet printing, spraying, screen printing, evaporation and sputtering. The isolated electrode is followed by at least one additional layer of ceramic polymer. More than one isolated electrode 234 may be used not shown, to further increase the failure resistance capability, where each isolated electrode is followed by at least one layer of ceramic polymer dielectric compound. The whole process is repeated for opposite electrode structure 233. The two different electrode layers are laid on top of each other building up the structure until the desired capacitance value is achieved. In FIG. 2C, 230 and 237 form the capacitor support substrates, 231 is the ceramic polymer dielectric material that fills the bulk of the capacitor, 232 and 233 the electrode structures often thin foil 0.01 to 10 ohm per square resistance for high impulse current capability, 235 and 236 are the electrical connections made to the capacitor electrodes in the same manner as FIG. 2A.

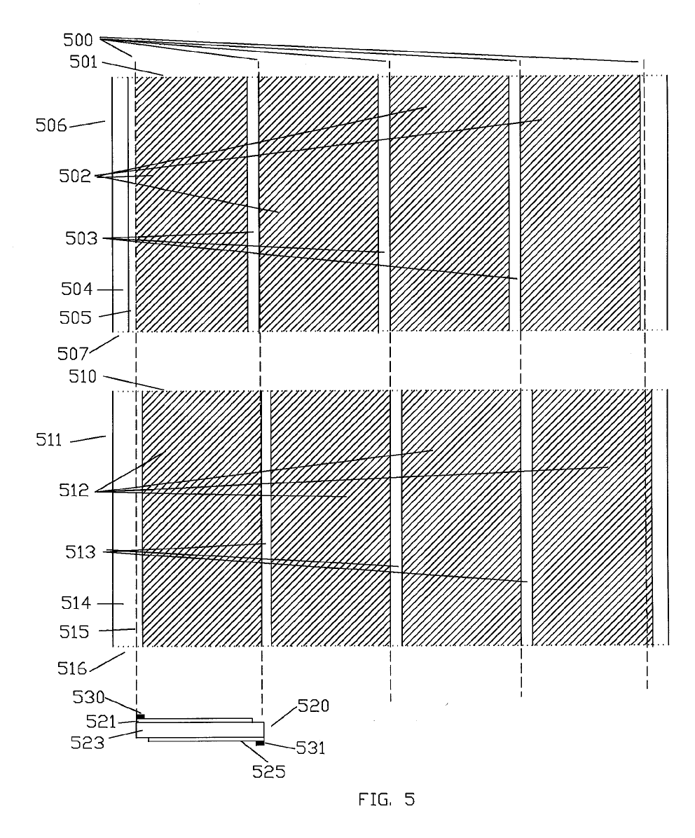

FIG. 2D is another design that has superior failure resistance capability relative to 2B, though more complex and often more expensive to manufacture. FIG. 2D is formed by two different carrier films 241 and 244, where each film has at least one layer of ceramic polymer dielectric applied before they are laid on top of the previous layer. The structure uses electrodes a variation of that represented by FIG. 4 or 5. In this example the electrodes are the same on each side of the carrier film. In FIG. 2D, 240 and 246 are the substrates the capacitor is assembled on, 241 the external electrodes often but not limited to 1 to 1000 ohm of aluminum a few 10s angstroms thick, 242 is the ceramic polymer dielectric that fills the bulk of the capacitor and 243 and 245 the end electrical connections made to the electrodes in the same manner as in FIG. 2A. The capacitor electrode carrier films do not carry any electrical voltage and only need to be of sufficient tensile strength to survive the mechanical stress of forming the ceramic polymer dielectric layers on top of them.

FIG. 2E is a low cost design well suited for low voltage ceramic polymer capacitors, where the carrier film is required to block the working voltage of the capacitor. The electrodes are often deposited directly on the carrier film such as represented by FIG. 5, 520. They are 1 to 1000 ohm often, but not limited to, aluminum a few 10s of angstrom thick and posses a degree of failure resistance if a short circuit should occur across the ceramic polymer dielectric. The capacitor is fabricated by depositing at least one layer of ceramic polymer dielectric 252 of the desired thickness on top of the carrier film. The films are then stacked until the desired capacitance value is achieved. In FIG. 2E, 250 and 255 are the substrates that support the capacitor structure, item 251 has both the left and right electrodes in addition to serving as a carrier film for the ceramic polymer dielectric. End terminations 253 and 254 are the electrical connections formed in the same manner as in FIG. 2A.

FIG. 2F is an electrode configuration well suited to the construction of high voltage capacitors often greater than 1 kilo-volt. The capacitor uses a number of intermediate floating electrodes that are coupled through common dielectric layers. The net effect is to make a capacitor that is a number of individual capacitors stacked in series with only one set of external electrodes. The reason for making a capacitor in this manner rather than using a much thicker dielectric layer is that research has found that the breakdown voltage, often expressed as volts/micron, of an insulating layer is not directly proportional to thickness but decreases the thicker it is made. For example a dielectric that is twice the thickness often has a working voltage that is only 1.8 times or less not twice as would be expected. Secondly, with a number of individual capacitors in series there are more intermediate layers to block the voltage between the end electrodes, should a single layer fail. Finally, the voltage applied across a defect is only that available in a single sub-layer rather than the total across the capacitor end electrodes, greatly reducing the heating of the defective area during a short circuit. In FIG. 2F 260 and 270 represent the substrate the capacitor is assembled on. The left output electrode is 261 and right is 267 with 265 and 263 the respective electrically conductive layer that joins all the common output electrodes together. Item 262 is the dielectric that fills the capacitor and reference 264 are intermediate floating electrodes. In this example the final capacitor is actually equivalent to 4 capacitors connected in series.

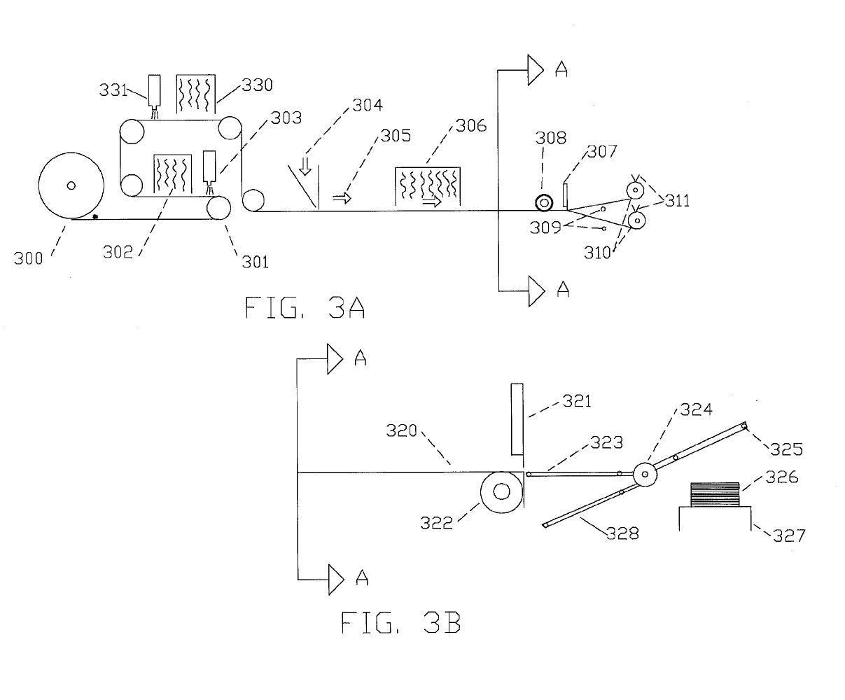

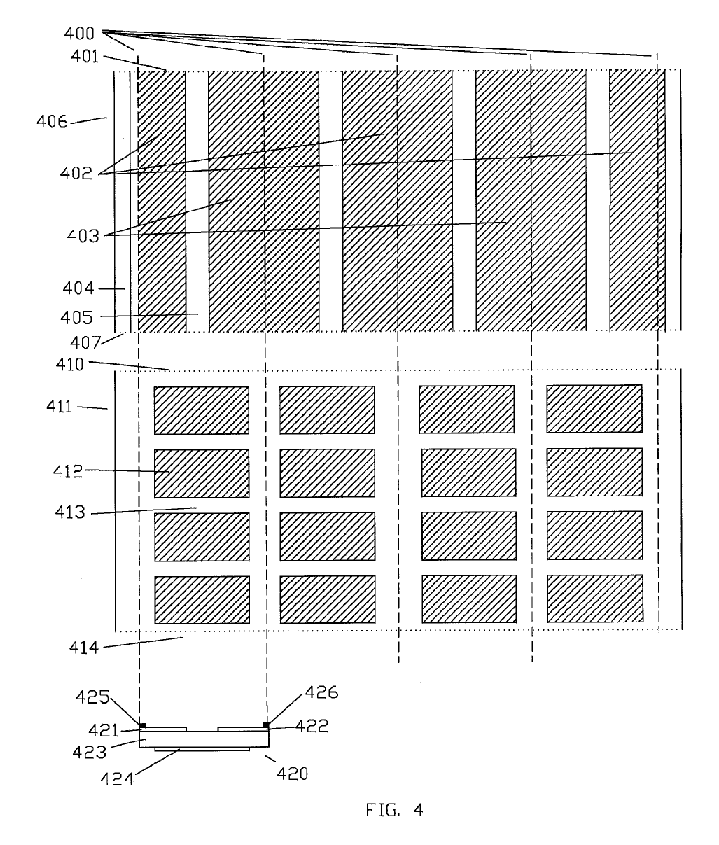

FIG. 3 is an embodiment of the invention that manufactures polymer or ceramic polymer capacitors of the type shown in FIG. 2. The capacitors manufactured by this process deposits the dielectric layer 305 on a substrate layer 300 that has the electrode structure of the capacitor already deposited on it. The substrate is often, but not limited to, a polymer film, while in other embodiments a material such as Kraft paper, of suitable tensile strength and thickness is used for the intended application. The dielectric layer that is deposited on the substrate is made of a polymer or polymer blend or ceramic polymer. The dielectric may be fully or partially cured during the fabrication process or after assembly into a capacitor. Often an external voltage of suitable DC/AC combination, for enhancement of the dielectric properties, is applied during the dielectric curing process

In FIG. 3 the substrate 300 is fed into the left side of the machine. The next process is optional but offers an alternative method to the problem of forming an external electrical connection to the electrode structure. This process applies a very thin electrically conductive polymer, often but not limited to, the bottom side of the sheet at the very end of the electrode where it exits the capacitor to the external electrical connection. The electrically conductive film may be applied to the film by any suitable process 303 such as spraying, transfer roller, industrial inkjet printing etc. and then allowed to dry and cure as required at 302. The film is then reversed in direction so the top layer may have an electrically conductive film, similar to 303, applied at 331, then dried and in some embodiments cured at 330 on the end of the capacitor where the electrical connection is made. The electrically conductive coatings 303, 331 are usually only applied to either the top or bottom side of the film depending on the final capacitor electrical construction. The electrically conductive coating is typically a few microns thick and does not extend into the area of the active dielectric. Often it is only partially cured so it flows out of the capacitor structure at a later fabrication step, to provide a larger area for attaching the external electrical connection to the inner electrode structure. FIG. 4, 425 & 426 and in FIG. 5, 530 & 531 are examples of where the electrically conductive polymer is placed. The substrate then proceeds to 304 where the dielectric layer is applied through a process such as the use of a Doctor Blade, used by the ceramic capacitor industry to make green ceramic tapes, spraying, silk screen, transfer printing, industrial ink jet or other process that is able to deposit the dielectric in a layer of suitable thickness. The dielectric material is often thinned with a suitable solvent to reduce its viscosity to that required by the deposition process. The thickness of the dielectric layer applied is dependent on the desired working voltage of the capacitor and its construction and is often in the range of 3 to 50 microns. After application the dielectric layer 305 it is dried at 306 to remove solvent and depending upon the capacitor construction, next cured either fully, partially or not at all. The substrate with the dielectric coating then proceeds to the capacitor assembly process, which is the section proceeding 306. In FIG. 3A an axial capacitor is assembled. The width of the substrate is large, typically representing 10 or more capacitors being fabricated at the same time. The substrate proceeds to slitter 308, which cuts the substrate into individual strips, in the direction of movement each of which is used to make one capacitor. Examples of the slit lines are shown in FIG. 4, 400 and FIG. 5, 500. The slit and coated substrates then proceeds to bobbins 311 where it is wound into a cylindrical shape, in a similar manner as a roll of tape, each of which in this case represents an axial capacitor. A cut off knife 307 is used to cut the coated substrate when the capacitor has reached the required diameter. Next the newly cut coated substrate strip is attached to the next set of bobbins 309, which was put in place to be used to make the next capacitor. The machine for the manufacture of capacitors is fully automated where the capacitor is made from start to finish through a sequence of processes. Next, in the preferred embodiment the finished capacitors proceed, not shown, to a curing process where a suitable electrical bias is applied across the external electrical terminations, during which time they are subjected to a high external pressure. The optimum values of the curing process such as time, temperature, electrical bias and pressure are experimentally determined prior to the capacitor fabrication and are specific to the dielectric used in the manufacture of the capacitors.

FIG. 3B is an alternate output section for finishing capacitors and is substituted into FIG. 3A at the line marked with ends A and A. This different alternate output arrangement of an embodiment of the invention is that a rectangular rather than an axial type of capacitor may be fabricated. In this example the substrate is represented by 320 and 322 represents the end roller of the conveyor belt that has been moving the substrate through the machine. Reference 321 is a shear used to cut the substrate into sheets where sheet transfer 323 takes a sheet from the bottom side and holds it to its surface typically using vacuum when a sheet has just been cut and then rotates around pivot 324 and deposits it on the capacitor stack 326, dielectric layer down. Reference 325 just shows the position 323 rotates to prior to placing the sheet face down on the capacitor stack 326 and 328 is another sheet transfer ready to take 323's place when it has a full sheet on its surface that is ready for transfer. The capacitor stack is formed on pedestal 327 that proportionally lowers its height after each substrate sheet is placed on it. When sufficient substrate sheets have been placed on pedestal 327 the capacitor stack is done and it is moved to the next stage. At the next stage, often pressure is applied, and the temperature increased to complete the curing of the dielectrics layers. Often an electric voltage comprising a suitable level of DC and AC is applied across the capacitors made at 3A or 3B as part of a dielectric property enhancement process. After the capacitor stack has been processed it is cut into individual capacitors, which go on to sorting and test. The advantage of this embodiment over previous art is that the process may be fully automated and the electrical connection to the inner electrodes is made using a simpler process with the external electrical connection made much thicker at the point of termination by the added electrically conductive layer deposited at 303 & 331.

The carrier films in FIGS. 4 and 5 are often made using a polymer that is used in conventional polymer film capacitor construction such as, but not limited to, polyester or polypropylene. FIG. 4 shows the capacitor electrode structure formed on a continuous carrier film. The sheet as shown is designed to simultaneously manufacture a number of capacitors using an electrode structure similar to FIG. 5, 520 and FIG. 2B or 2E. In FIG. 4, 406 is the top layer of the film, 411 the bottom layer and 420 a cross section of one strip. The dielectric would be deposited on the top surface of the carrier film prior to slitting or cutting the film into sections along reference lines 400. The explanation of each element is as follows, 404 represent the edge margin of the film to be discarded. Item 402 would be a capacitor electrode, 403 the opposite polarity electrode, both make electrical connection outside of the structure and are electrically isolated from each other by the areas without metal film 405, represented by white space. Lines 401, 407, 410 and 414 represent the fact that the sheet is continuous and only a small segment is shown. White space 413 is the electrically insulating area on the bottom of the sheet that is free of electrically conductive electrodes. Areas 412, all are hatched and represent areas that are electrically conductive, often, but not limited to, 1 to 1000 ohm aluminum a few 10's of angstroms thick, that have no outside electrical connection as the electrically conductive area is well back from the cut lines. The electrode layer on the underside is segmented into isolated areas of a specific size. The purpose is to limit any permanent dielectric short circuit to a small area of the capacitor. Additionally, this limits the energy released during the dielectric short circuit to a predetermined level and if the fault is not cleared, only a small portion of remaining ceramic polymer is subjected to higher operating voltage. The segmenting of the inner electrode is predominately used only on capacitors with large amounts of stored energy, providing a further level of protection, improving capacitor reliability. The extra protection allows higher voltage stress to be applied to the ceramic polymer without affecting production yield or product reliability, making the capacitor smaller and lowering cost. Item 420 is a cross section of the carrier film where 421 is the left electrode, 422 the right electrode both of which have outside electrical connections. Item 424 is an electrically isolated or floating inner electrode and 423 represents the electrically insulating carrier layer. The carrier layer as shown is a design that would often be used to manufacture an axial style of capacitor. To make a stacked version the top electrodes require horizontal zones along the horizontal cut lines, that are free of electrically conductive film and would appear similar to the bottom layer except the electrically conductive films would be in line with the existing top strips and the end result, when cut into individual electrodes, look similar to FIG. 5, 520. The electrode films are often 1 to 1000 ohm per square, often aluminum a few 10s of angstroms thick, deposited in any manner that provides an electrically conductive film with the desired properties. Alloys other than aluminum may be used but they should form an electrically insulating material after the dielectric short circuit has cleared. Other electrode shapes or patterns are fabricated through the use of masks during the vacuum deposition process. Alternately, in other embodiments, the electrode patterns are formed after deposition by selective etching through the use of a suitable masking process. The masks protect areas where the metalization is desired and chemicals are used to selectively remove metal from those areas that are desired to be electrically insulating.

FIG. 5 represents another variation of carrier film pattern that may be used in the construction of the capacitor structures. In FIG. 5, 506 is the top layer, 511 the bottom layer, 500, 515 the slit lines for separation after manufacture. Item 504 and 514 are the edge keep back zone, discarded during manufacture, 502 the left electrode, with 512 the right electrode located on the bottom layer. Reference 503 & 513 are electrically insulating areas that are devoid of electrode metalization. Item 520 represents a cross section of the film, 521 the left electrode, 525 the right with 523 the carrier film that is subjected to voltage stress equal to that across the ceramic polymer dielectric and must withstand the mechanical stress of forming one or more ceramic polymer layers on top of it before assembly. FIG. 5 represents a continuous film structure typically used in the manufacture of an axial capacitor. Reference 501, 507, 510 and 516 representing apportion of a continuous sheet. The electrode electrically conductive films are often 1 to 1000 ohm aluminum a few 10s of angstroms thick, deposited in any manner that provides an electrically conductive film of the desired properties. Alloys other than aluminum may be used but they should form an electrically insulating material after the dielectric arc has cleared.

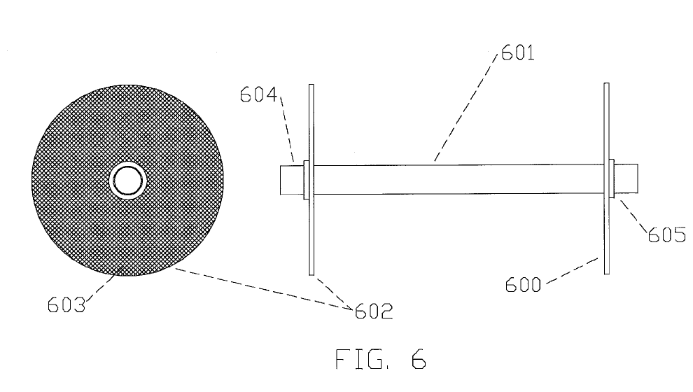

FIG. 6 represents a capacitor bobbin used by the embodiment of the invention represented by 3A. Reference 601 is an electrically insulating center upon which the dielectric coated substrate is wound upon and where 604 & 605 represent the electric terminations. Often 601 is made hollow to allow a liquid or air to circulate through it for cooling purposes. Alternately it is made from a thermally conductive electrically insulating material such as aluminum oxide to facilitate heat removal from the inner portion of the capacitor. References 600, 602 & 603 are a perforated electrical conductor used to make electrical contact with the capacitor electrodes. During the fabrication process a suitable electrically conductive polymer mixture is applied to the very ends of the two electrodes that exit the capacitor, often just before it is wound upon the bobbin. The pressure of the winding film causes this electrically conductive polymer to flow out and make contact with the end of the bobbin, and then it is cured, completing the electrical connection. Care has to be taken to ensure the electrically conductive polymer mixture does not flow into the active dielectric part of the capacitor.

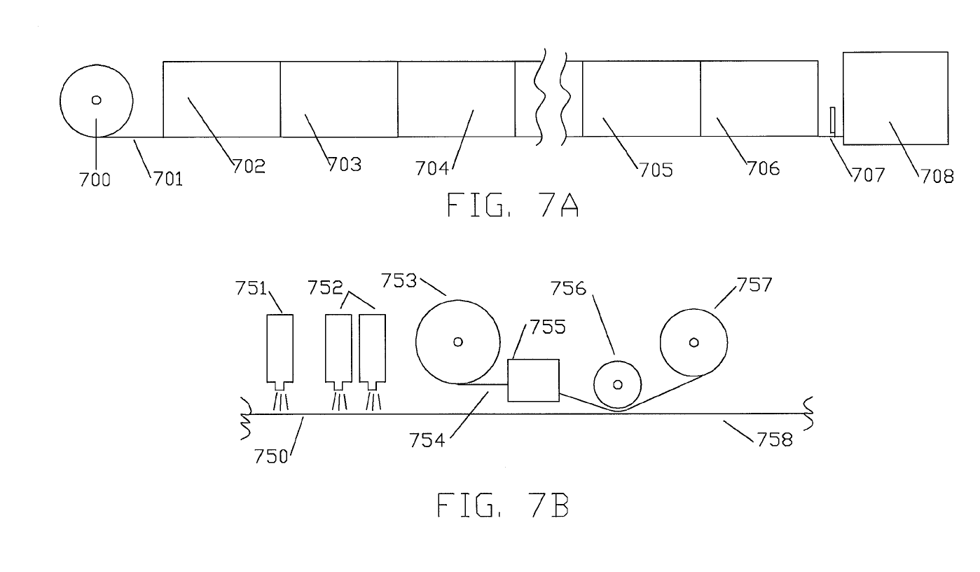

FIG. 7 represents the preferred embodiment of the invention. It has many advanced features that solve a number of the existing problems of current polymer or ceramic polymer capacitor manufacturing. The construction of the capacitor starts at the left and progresses to the output at the right. Reference 700 is often, but not limited to, a roll of polymer film used as a substrate 701 upon which the capacitor is constructed. Sections 702, 703, 704 and 705 represent a number of identical sections, each of which applies at least one layer of the capacitor structure. Section 706 represents where the top of the capacitor is applied either as a polymer or continuous sheet of polymer similar to the substrate. The top protects the interior of the capacitor from external contamination in the same manner as the substrate, which later becomes the bottom of the capacitor. The total number of sections maybe as little as one or may total over 30, depending on the size of the capacitor section being constructed. Reference 707 a sheer for cutting the output of the machine into sheets of capacitors which are then transferred to 708 where the capacitors are often placed under pressure with a predetermined electrical bias applied to enhance the properties of the dielectric layers and finally the temperature increased to cure the dielectric polymer or ceramic polymer as necessary. The end results are sheets of individual finished capacitors ready for separation. It is obvious that the output section 706, 707 & 708 can be replaced by that used in 3A after the vertical reference cut line denoted by A & A.

FIG. 7B represents the components typically found inside the sections 702, 703, 704 & 705. In the preferred embodiment an electrically conductive polymer mixture is applied by industrial ink jets 751 to the end of the capacitor where the external electric termination is made using a similar method as represented by FIG. 3. Reference 750 is the substrate layer upon which the capacitors will be formed. Next the dielectric layer is deposited by a group of industrial inkjets and may be a polymer mixture or ceramic polymer mixture. After a suitable drying time the electrode layer is applied by a transfer process comprising of 753 a roll of polymer film with the electrode structure 10's of angstroms thick 10 to 1000 ohm per square deposited on its surface. Often the electrode is made of aluminum, zinc aluminum or other suitable material that converts into an inert electrical insulating material when it is subjected to an electrical arc, caused by a short circuit in the dielectric layer. Reference 755 is a bath containing a solvent that will reduce the adhesion of the electrode structure to the polymer film sufficiently that it will lift off or transfer to the surface of the deposited dielectric layer under the action of the roller 756. This method of transfer printing uses a solvent release transfer process. Another method that is used in other embodiments is a thermal transfer process. In the thermal transfer process heat is applied to the polymer film, often melting another very thin low temperature melting polymer layer that is located between it and the metal layer. This releases the adhesion of the metal layer to the polymer film, allowing the metal film to transfer to the target substrate. The polymer film, less the electrode layer is taken up onto roll 757. Reference 758 is the sheet of capacitors with the newly deposited end termination layer, dielectric layer and electrode structure. The transferring of just the self-healing electrode layer without the carrier polymer film reduces the capacitor thickness by omitting the 10-micron polymer carrier film. This is major improvement from the method used by FIG. 3, increasing the energy density in some designs by over 2 times and reduces by half the cost of manufacture. The polymer film 757 can often be reused a number of times.

In FIG. 7B 753, 754, 755, 756 and 757 can be replaced with a group of industrial inkjets in a similar location as 751, which would print the electrode pattern using suitable electrically conductive inks on top of the dielectric layer. Alternately any other printing method such as screen printing, transfer roller etc. could be used for depositing the electrode and dielectric layers. However, the printing of the electrode area often would create a raised surface of greater than 0.1 micron thick with often poor to no self-healing properties. The added material and thickness increases the cost of the capacitor.

The problem solved by printing the electrodes is that the machine will not require the rolls of polymer containing the electrode material. However, each roll of electrode material is about 1 meter in diameter and 75,000 meters long, capable of producing a 75,000-meter line of capacitors from the machine. This is enough material for 30, 24-hour days of production.

Another advantage of printing the electrodes is that a machine could be constructed using a single set of electrode industrial inkjets and a second set of dielectric deposition industrial jets. The substrate would be a single substrate sheet that is continuously passed forward then backward under the industrial inkjets with another capacitor layer added by each pass. This type of machine could then be used for the testing of new materials or very small custom batches of capacitors. In this example then FIG. 7B would be modified, as follows 750 is the substrate that is passed forward then backward under the industrial inkjets 751 and 752. The industrial inkjets 751 would print the electrode structure and 752 the dielectric layer. The process would continue building up layers until the required number has been deposited, then an electrically insulating layer is applied to the top of the sheet of capacitors. Next the sheet of capacitors would be processed in the same manner as a sheet made by FIG. 7A.

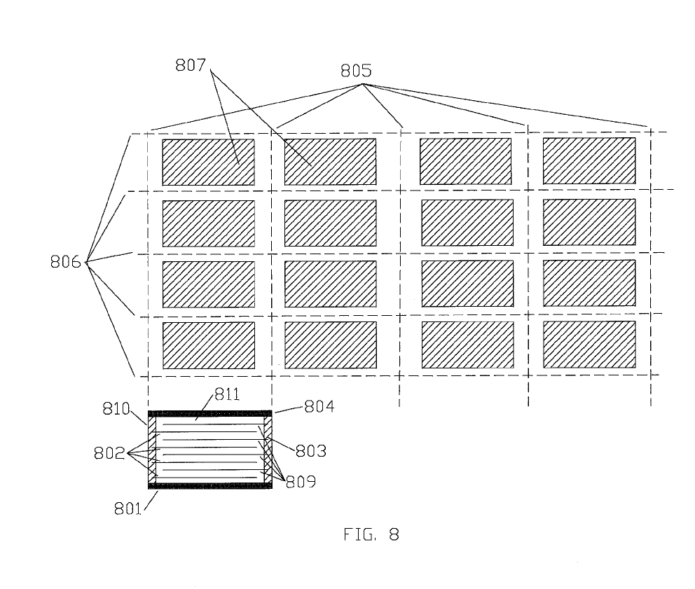

FIG. 8 shows a typical sheet of capacitors made by the process of FIG. 7 where reference 807 represents the capacitors, 805 and 806 the exaggerated margin for separating them from each other. A cut away view of the finished capacitor is shown where 803 & 810 are the end electrical terminations, 801 & 804 the insulating top and bottom layers where 801 is the original substrate the capacitor was constructed on. Reference 802 is the left internal electrode structure connected to 810 end electrical termination, isolated from the right electrode structures 809, and 803 the right and right end electrical terminations. Reference 811 is the dielectric layer that stores the electrical energy and isolates electrically the left and right electrode structure. One major improvement of the preferred embodiment represented by FIG. 7 that manufactures capacitors similar to FIG. 8 is the elimination of the electrode support structure found in FIGS. 2, 4 and 5 used by the embodiment represented by FIG. 3.

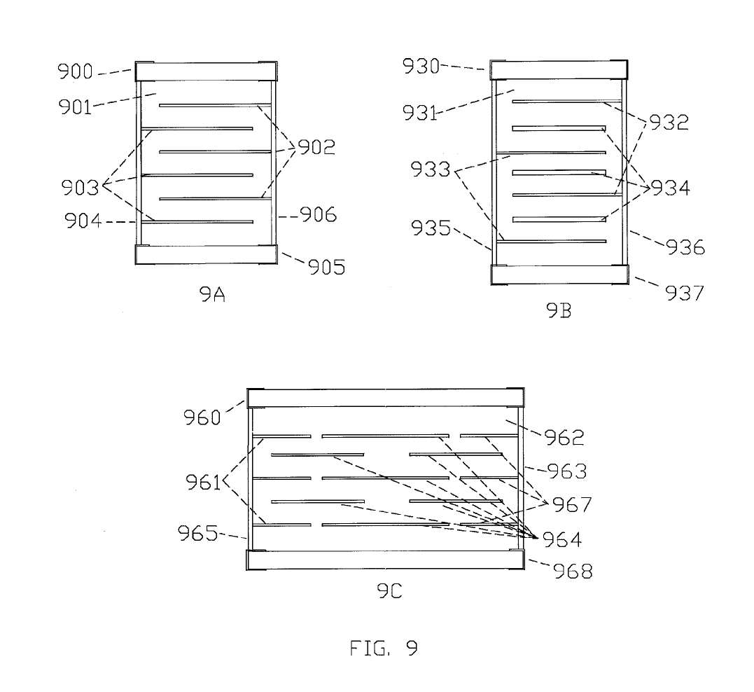

FIG. 9 shows the cross sections of various capacitors that can be manufactured by the preferred embodiment represent in FIG. 7. FIG. 9A is the same as FIG. 2A where 900 through 906 are similar to FIG. 2A 200 through 206 respectively in function. FIG. 9B is the same as FIG. 2C where 930 through 937 are similar to FIG. 2C, 230 through 237 respectively in function. FIG. 9C is the same as FIG. 2F where 960 through 968, excluding 966 are similar to FIG. 2F where 260 through 268, excluding 966 respectively in function. Once again the major improvement of the preferred embodiment represented by FIG. 7 that manufactures capacitors similar to FIG. 9 is the elimination of the electrode support structure found in FIGS. 2, 4 and 5 used by the embodiment represented by FIG. 3.

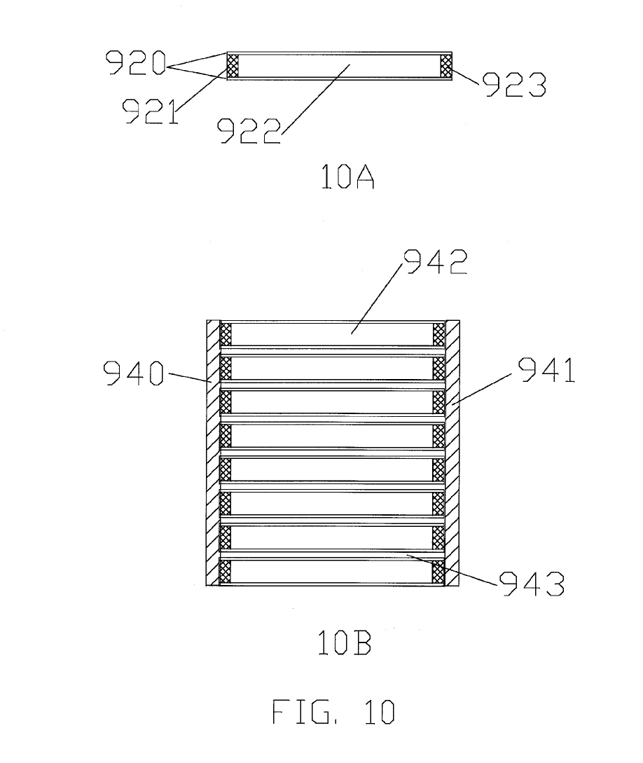

FIG. 10 represents the stacking of a large number of rectangular capacitors manufactured by the embodiment represented by FIG. 7, to construct a single much larger capacitor. One problem of manufacturing rectangular capacitors using the preferred embodiment of FIG. 7 is that manufacturing a capacitor 1 cm (10,000 micron) in height requires 1,000 individual dielectric/electrode layers each of which combined are typically 10 micron or less in thickness. A manufacturing machine constructed according to FIG. 7 would need 1,000 individual depositions sections to make a capacitor 1 cm thick. A practical design would be able to manufacture capacitors between 30 to 50 10-micron dielectric/electrode layers for a capacitor of 0.03 to 0.05 cm in height. To get 1 cm of height would require 33 to 20 of such capacitors stacked on top of each other. This can be done as an automated process where sheets of capacitors are stacked on top of each other, bonded together then cut into individual capacitors after processing has completed. FIG. 10A shows a separate single capacitor made by the preferred embodiment represented by FIG. 7 where 920 is a protective top and bottom layer on the capacitor. Reference 921 is the left external electrical connection to the left internal electrodes located inside the capacitor and 923 is the right external electrical connection to the right internal electrodes located inside the capacitor and electrically isolated from the left electrodes. Reference 922 is the internal electrode and dielectric layers not shown.

FIG. 10B represents a special circumstance of stacking individual capacitors to form a much larger device. In FIG. 10B, 940 is an external electrical connection to all the individual capacitors' left electrical connection and 941 the same for the right side electrical connection. Both 940 and 941 often have various attachments such as screw terminals, solder lugs, quick disconnects etc. attached to them, not shown for purposes of clarity. Reference 942 is an individual capacitor and 943 a small space left between each capacitor. This space is often required for dielectrics that undergo a large mechanical deformation when they are charged such as that experience by a ceramic polymer containing Barium Titanate. Alternately the space may be left open for air or liquid to be passed through for cooling or filled with a solid thermally conductive material such as copper or aluminum etc. to remove excess heat away from the inner portion of the finished capacitor. The end terminations 940 and 941 can be attached to the individual capacitor terminations 921 and 923 respectively by using an electrically conductive polymer or soldering, the method depending on the final capacitor specification.

FIG. 11 represents another embodiment of the invention. The purpose of this embodiment is to reduce greatly the number of individual sections required to manufacture a capacitor. This is of considerable importance when building a small quantity of capacitors for experimental purposes or for applications requiring a small number of custom fabricated devices. In this embodiment the large number of the deposition sections in FIG. 7 are replaced by a much lower number spaced around the outside of a rotary wheel. Instead of the capacitors being deposited on a substrate on a conveyor belt in FIG. 7 they are deposited on a substrate mounted on the out side of a rotary wheel in FIG. 8. The advantage is lower cost and less floor space required per capacitor station. In FIG. 8 353 represents the rotary point around which the wheel rotates, 352 a spoke of the wheel and 354 a space, greatly exaggerated. The substrate layer 351 is placed on the outer rim of the wheel, 350 represents the multiple electrode dielectric layers already built up. Reference 360 & 362 is for depositing the dielectric layer by industrial inkjet, spraying, transfer printing or other acceptable process. Reference 355 through 359 and 363 through 367 are used for depositing the electrode layer using a transfer process in the exact same manner as in FIG. 7B 753 through 757. In FIG. 11, 355 & 364 are rolls of polymer with the electrode layer to be transferred deposited on its surface, 359 & 363 the polymer film. Reference 356 & 365 is the region where the polymer is softened such that the electrodes adhesion to the surface is greatly reduced to facilitate the transfer process. Reference 357 & 366 is the transfer roller and 358 & 367 the take up roll for the polymer film left over after the electrode layer has been removed. As in FIG. 7 the electrode is often aluminum, aluminum zinc or other alloy a few 10s of angstroms thick, with resistance 10 to 1,000 ohm per square that forms an inert electrically insulting layer when subjected to the energy of a dielectric short circuit. The electrode acts in the same way as an electrical fuse does in a home. If there is an electrical fault it disconnects the damaged or shorted part of the dielectric layer from the rest of the capacitor. This is called self-healing meaning a short circuit in a part of the capacitor does not short out the whole capacitor but only the area of the fault. One problem that FIG. 11 has is that the spacing of the electrodes on the outer layer shifts slightly as the thickness of the capacitor builds up. This effect is the result of the outer perimeter of the capacitor being a direct function of the radius, where the outer perimeter increases by 2 times pi times the change in radius. For example an increase in radius by 1 cm increases the outer perimeter by 6.28 cm. Changing the speed of the placement of the electrode film and decreasing it proportionally as the thickness of the capacitors grows, can correct the problem. An alternative method to solve the problem is to use an electrode film where the electrode spacing slowly increases as the capacitor gets thicker, however this method requires a lot of coordination between the manufacturer of the roll of electrodes and capacitor fabrication facility. An alternate method is to use an industrial inkjet printer (very similar to the printer head used in an ink jet printer) to deposit the electrode layers. Removal of the cylinder of capacitors from the fabrication wheel can be accomplished by withdrawing slightly inward one or more spokes of the wheel and gripping the capacitor on its inner surface through the slots in the wheel 354. Another difference represented by this method of capacitor construction is that the capacitors have to be separated in a slightly more complex manner than that used for a flat sheet made by FIG. 7. A convenient method of separating the capacitors is by using a laser cutter. The capacitors are processed after construction in the same manner as in FIG. 3 and FIG. 7, using controlled heat and pressure to cure the polymer or ceramic polymer dielectric while at the same time a suitable electrical bias of DC and AC is applied across the electrical end terminations. A final disadvantage of capacitors made in this manner is that they will not be perfectly flat, but have a slight arc to their body, depending upon the length of the capacitor body and radius of the wheel. Often this is not a problem as capacitors of this type will be stacked as in FIG. 10 and boxed in a rectangular package. The capacitors will appear to be similar to FIG. 8 except the sheets have a slight bend in them from the arc of the wheel. There is a third solution to the slight bend in the capacitor body and that is to cut the capacitors then compress them slowly and carefully until the arc is removed from the capacitor body. The disadvantage of this process is that it is best done prior to curing of the dielectric layer and results in the shifting of the internal layers, placing mechanical stress on the dielectric and inner electrode surfaces.

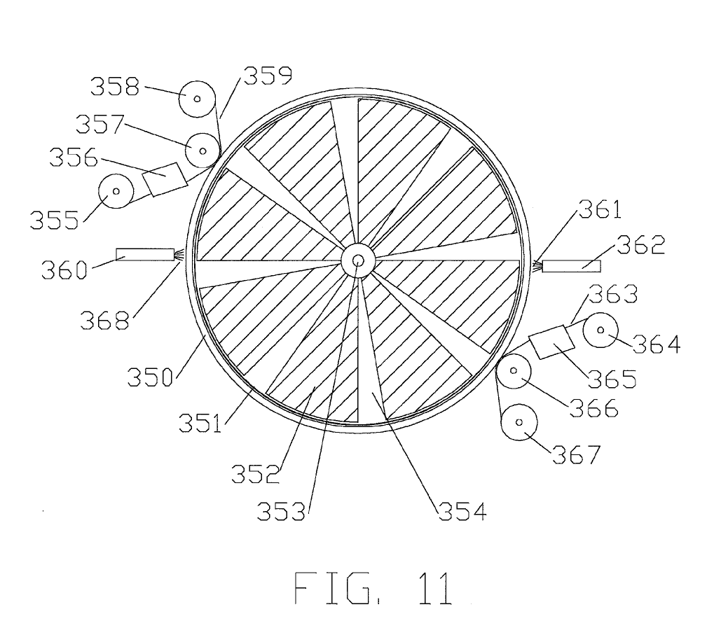

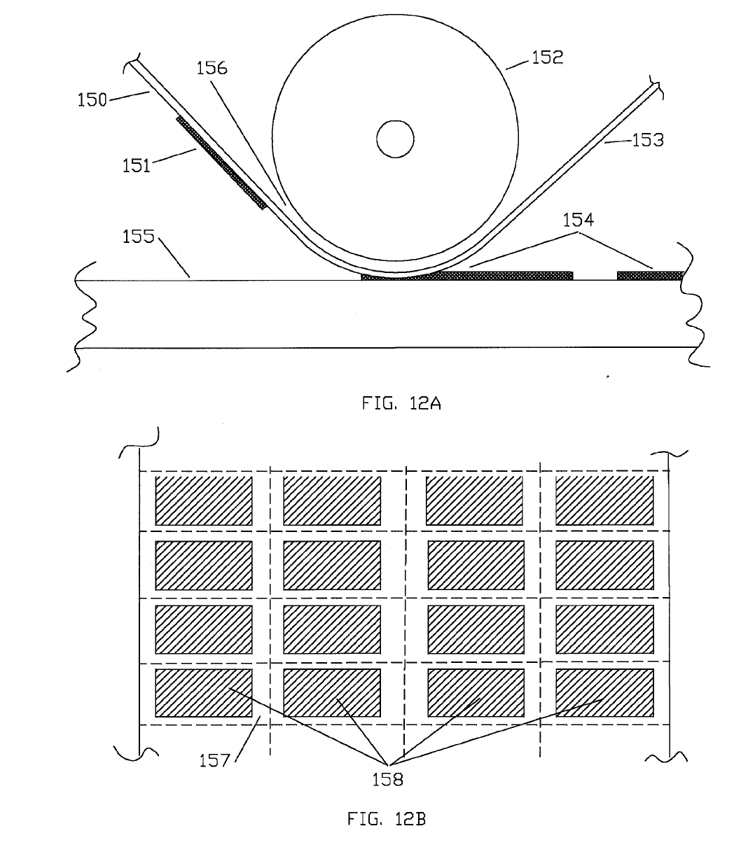

FIGS. 12A & 12B is an expanded view of the process used to transfer an electrode from the surface of a polymer film onto the top of a dielectric layer used by the embodiments shown in FIGS. 7 and 11. In FIG. 12A 155 represents the dielectric layer that the electrode is to be transferred on to 150 is the polymer layer that has the electrode deposited on, 151 the electrode to be transferred, with the vertical height greatly exaggerated for purposes of clarity and 152 is the transfer roller. Reference 156 is a small air gap between the sheet of polymer with the electrode on top and the actual roller. Using a porous material for the transfer roller through which air or gas is forced creates this air gap. This puts a layer of air under low pressure between the roller and the sheet of polymer. The purpose of this layer of air is to ensure that a uniform low pressure is applied evenly across the polymer sheet as the electrode is transferred. The air acts as a fine height adjustment as the polymer is deposited in layers often 5 or 0.005 millimeter thick and the ability to precisely set the height of the roller is often limited to 0.02 mm. Reference 154 is the electrode that was transferred and 153 the polymer sheet returning to a take up roller, which is not shown.

An example of how electrodes can be transferred from a polymer sheet is demonstrated by using Trichloroethylene to soften a 12-micron thick propylene film with a self-healing aluminum structure deposited on its surface. The aluminum layer is very thin, just 10s of Angstroms and often partially optically transparent. Soak the propylene film for a couple of minutes in Trichloroethylene, take out and let dry a minute, then place on top the aluminum structure a piece of adhesive tape. Lifting the tape transfers the aluminum structure to its surface without damage. The Trichloroethylene reduces the adhesion of the aluminum to the surface of the propylene sheet and causes the propylene to swell as the Trichloroethylene is absorbed. The combine action of the propylene swelling and the reduction of the adhesion of the aluminum to its surface facilitate the transfer process. It is obvious that other polymers with poor surface adhesion properties such as Teflon may be used in place of the propylene along with a solvent other than Trichloroethylene.

FIG. 12B is very similar to FIG. 8 and shows a portion of the sheet of capacitors fabricated by the embodiment represented by FIG. 11. In FIG. 12B, 158 represent the many rows of capacitors, in this example, where 4 of them take up the space across the full width of the wheel. Reference 157 is the lines through which the capacitors are separated. The capacitors after separation are finished in a similar manner as those represented by the capacitor sheets in FIG. 8.

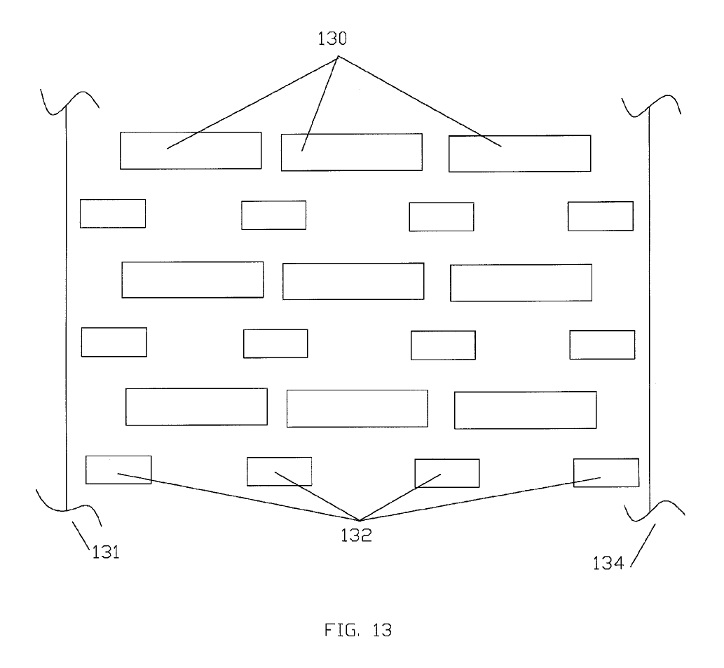

FIG. 13 is a representation of a set up of industrial inkjets used by embodiment in FIGS. 3, 7 and 11. In FIG. 13, 130 would represent the blocks of industrial jet printers that deposit the dielectric layers. In this example the industrial inkjets deposit dielectric layers are as wide as the whole capacitor, which in this example, 3 are placed across the sheet. Reference 132 represents the smaller industrial inkjets used to deposit the electrically conductive polymer that connects the internal electrodes to the exterior electrical connection. Embodiments that use the industrial ink jet configuration of FIG. 13 often use the transfer printing process of FIG. 12A to deposit the capacitor electrodes. Other embodiments deposit the electrode structure using industrial ink jets by the addition of a second row similarly sized and configured as reference 130.

One aspect of all embodiments represented by FIGS. 7 and 11 is that the capacitors can be deposited in manner where they are separated from each other sufficiently so that all that holds them together is the substrate that they are deposited on. The separation is created by depositing the dielectric and electrode layers such that a small gap exists between adjacent capacitors. This solves the problem of damage from the mechanical stress they are subjected to during separation.

In the embodiments represented by FIGS. 3, 7 and 11 the electrode may be a foil instead of a thin film. Foil or thick electrodes are used for capacitors in high current pulse applications. Capacitors of that type are often compatible with electrodes that are printed using a process such as industrial ink jet.

In the embodiments represented by FIGS. 3, 7 and 11 often the printed electrodes are made from an electrically conductive polymer or polymer conductive particle mixture that upon being subjected to the energy of a short circuit across the dielectric converts into an electrical insulating layer, disconnecting the shorted dielectric from the rest of the capacitor in the similar manner as a fuse. All printable materials that are electrically conductive and able to be transferred to the surface of the dielectric layer are compatible with all aspects of the embodiments represented by FIGS. 3, 7 and 11. All embodiments may use sheets made from materials other than polymer, for example Kraft paper, so long as they have the mechanical and electrical properties required by the various process steps. Furthermore, often all aspects of the embodiments represented by FIGS. 3, 7 and 11 use electrode structures made from corrosion resistant metals such as gold, nickel, tin alloy, etc. for one or more of their electrodes.

All aspects of the embodiments represented by FIGS. 3, 7 and 11 may be used for the manufacture of piezo transducers used for the generation of sound or electro mechanical displacement devices that converts electrical energy to mechanical motion and force instead of capacitors. The dielectric constant of capacitors manufactured by any embodiment of the invention can be designed to remain unchanged, increase or decrease in value in response to externally applied pressure, voltage and temperature.

Aspects of the embodiments represented by FIGS. 7 and 11 maybe used for the fabrication of green multi-layer ceramic capacitor bodies where the electrode material is often made from nickel or other metal alloy compatible with the high firing temperatures used in ceramic capacitor manufacture. The use of very thin nickel film, angstroms thick or other suitable alloy departs a degree of failure resistance to the ceramic capacitor structure. The nickel film can have metal deposited on both surfaces, for example kovar, or tungsten, copper etc. that readily oxidizes and bonds the nickel electrode to glass and ceramic materials. This reduces the problem of delimitation between the ceramic and metal electrode layers. An electrode structure of this type often uses an electrode that is thin in the active capacitor dielectric area but thickened near the end where the external electrical connections are made. This provides a greater cross-section of material available to make an external electrical connection to the inner electrodes. This similarly applies to any capacitor structure that is manufactured in a similar manner as a ceramic capacitor. Using the methods of capacitor fabrication represented by embodiments represented by FIGS. 7 and 11 can reduce the cost of manufacture by providing an easily automated volume manufacturing process that is precisely controlled. However, the main benefit of the use of the embodiments of the invention is that the capacitor electrode can be made 10's of angstroms thick rather then 0.2 microns. Such a thin electrode has the potential of imparting self-healing to the ceramic capacitor structure which to date no commercial manufacturing process has been capable of doing. The imparting of self-healing to the ceramic capacitor structure will greatly reduce the cost of manufacturing ceramic capacitors and improve their reliability in the electronic circuits that they are used in.

In all aspects of the embodiments represented by FIGS. 3, 7 and 11, the industrial inkjets may be replaced by any process that will deposit the dielectric or electrode layers in an acceptable method. Some of these other methods are but not limited to spraying, silk screen-printing, direct printing, transfer printing etc.

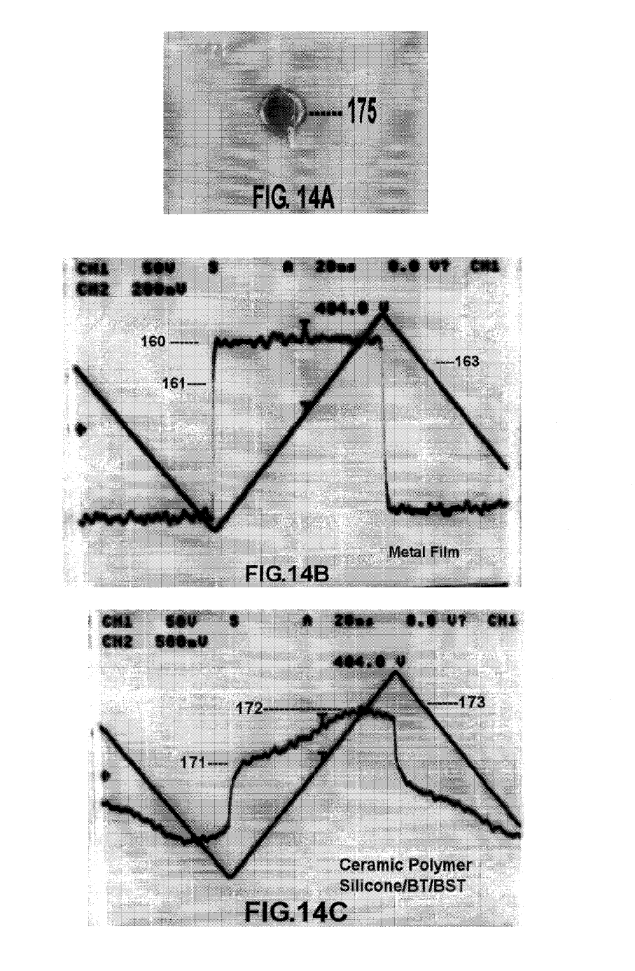

FIG. 14A is a highly magnified picture taken from a microscope. Reference 175 is a defect in a ceramic polymer dielectric layer that caused an electrical short circuit in the test capacitor. The short circuit was successfully cleared with the electrode disconnected from around the defect. The energy discharged into the ceramic polymer created gasses that lead to an expansion of the dielectric, resulting in a small crater a few 10s of microns across. The capacitor cleared and continued to function without problems. The dielectric was fabricated using a silicone polymer with approximately 40% by volume Barium Titanate ceramic.

FIG. 14B is an oscilloscope picture of the electrical response of a commercial metalized film capacitor with specifications of 15 nF and 400V. This capacitor was purchased and was not made using any of the embodiments of the invention. Reference 161 is the electrical current through the capacitor, as measured across a 10 k resistor placed in series with the ground terminal. The current 161 in this picture is 20 uA/Div and the applied voltage 163 is a continuous ramp of 50 Volt/Div. The current response in a capacitor in this example has a flat current response to a constant rate of change of voltage. This constant current creates a flat top represented by 160. A flat current response implies that the dielectric constant does not change in response to the applied voltage. This is typical for most metalized film capacitors that use a polymer dielectric.

FIG. 14C is a self-healing ceramic polymer capacitor made according to embodiments of the invention where the dielectric is a ceramic polymer. The capacitor is approximately 35% by volume a ceramic mixture of Barium Titanate and Barium Strontium Titanate and the remaining 65% a silicone polymer jell. Silicone jells contain large amounts of uncured silicone oil and in this example the amount is estimated to be in excess of 50%. This example verifies that a capacitor could be fabricated from a dielectric composed of a sold and uncured liquid phase. The ceramic powder was added without a dispersing agent. Reference 171 is the current, measured as a voltage across a series resistor placed in the ground leg of the capacitor, representing 50 uA/Div. Item 173 is a constant ramp voltage applied across the capacitor. 50 Volt/Div. Reference 172 is signature behavior of a capacitor made use an embodiment of the invention. The dielectric constant increases in response to an increasing applied voltage. In this example the capacitance varies in relation to the applied voltage and frequency. At very low frequencies, <5 Hz and high-applied voltage the capacitance is about 6 times that measured at for example 10 kHz with similar applied voltage. The test capacitor has a peak capacitance of about 60 nF, with a static value at 1 kHz and low voltage of 7 nF. Additionally, the capacitor current has a relaxation step response to an applied square wave and a triangular shaped waveform in response to a sine wave voltage. The detailed response and behavior of the capacitor would fill a number of pages. The behavior of the dielectric is very similar during the curing process. The dielectric value often increases by over 10 times in response to the appropriate value of DC and AC voltage applied during the curing process. During the capacitor curing process the higher dielectric constant is locked in.

In FIG. 14C the capacitor was made using a silicone polymer with a very low dielectric constant of 4. Substituting the polymer with a much higher K material would result in a much larger value of capacitance. Using the preferred embodiment a capacitor such as represented by FIG. 14C would be made with an equivalent electrode area of 0.6 square inches and a thickness of 2 mil or 0.002 inches for a volume of 0.0012 cubic inches. A large capacitor could be manufactured from the dielectric used in this example. Such a capacitor would have a static capacitance of 8 uF per cubic inch and a peak capacitance of 50 uF at a maximum working voltage of over 1,000 Vdc. However, the dielectric in this example is not representative of the dielectrics that would normally be used in a capacitor manufactured using the preferred embodiment. Such a capacitor would have a static capacitance of over 800 uF per cubic inch.

Although the invention has been described in connection with a preferred embodiment, it should be understood that various modifications, additions and alterations may be made to the invention by one skilled in the art without departing from the spirit and scope of the invention as defined in the appended claims.

What is claimed is:

1. A capacitor fabrication process comprising;
a) a continuous polymer sheet that is to be used has at least a portion of the electrical structure of a capacitor, with electrically conductive structures previously deposited on both its surfaces, is fed into one end of a fabrication machine wherein a capacitor structure is to be formed on the sheet's surface; and
b) next the polymer sheet proceeds through a process stage wherein an electrically conductive mixture is deposited by a controlled process on the portions of the electrode structures that are not dielectrically active and where the electrodes exit the capacitor structure to facilitate the making of an external electrical connection to the inner portion of the electrode; and
c) next the polymer sheet proceeds through a drying stage to suitably remove any solvents that remain in the electrically conductive mixture; and
d) next the polymer sheet proceeds through a process stage wherein a dielectric layer is selectively deposited on the polymer sheet by a controlled process to form the dielectric of a capacitor; and
e) next the polymer sheet proceeds through a drying stage to suitably remove any solvents that remain in the electrically conductive mixture and dielectric layer; and
f) next the polymer sheet proceeds through a stage wherein it is continuously slit into one or more strips of a predetermined width; and
g) next the polymer sheet proceeds through a stage wherein the individual strips of the polymer sheet are wound onto bobbins to form axial capacitors; and
h) when a bobbin reaches a predetermined diameter the continuous strip of polymer sheet is disconnected from the full bobbin; and
i) then the individual strip of the polymer sheet is connected to a new bobbin; and
j) a protective wrap or coating is put around the outside of the full bobbin forming a capacitor; and
k) then the capacitor is moved to the next stage of processing where its electrical terminations are modified; and
l) the capacitor is moved to the next stage of processing where it is subjected to a predetermine profile of pressure, temperature and electrical stimulus to alter the capacitor's mechanical and electrical properties to comply with a preset specification; and
m) then the capacitor is visually inspected and electrically tested.

2. As in claim 1 except the polymer sheet is already the required size to fit a single bobbin wherein the slitting process is omitted.

3. As in claim 1 except the process is modified such that at least one additional continuous polymer sheet, with at least a portion of the electrical structure of a capacitor, with electrically conductive structures previously deposited on both its surfaces, is fed into the fabrication machine after the electrical conductive and dielectric layers previously deposited have suitably dried, thus forming another layer of the capacitor structure whereupon additional electrical and dielectric layers are deposited in a controlled process similar in manner to the previous process stages to form a layered structure which is then suitably dried and subjected to the remaining process stages.

4. As in claim 1 wherein the controlled deposition process used for the electrically conductive and dielectric layers is one of but not limited to a printing process such as silk screen, transfer, offset, industrial ink jet, spraying.

5. As in claim 1 wherein at least a portion of the electrode layer used in the fabrication process is self-healing such that should a portion of dielectric layer form an electrical short circuit it is disconnected from the rest of the capacitor structure.

6. As in claim 1 wherein at least a portion of the electrode layer used in the fabrication process is corrosion resistant to prevent any chemically active free radicals that are generated throughout the life of the capacitor from eroding the capacitor electrode.

7. As in claim 1 wherein a portion of the electrode structure that is in areas that are dielectrically active are printed using an electrically conductive material such as but not limited to conductive ink.

8. As in claim 1 except the sheet that the capacitor structure is fabricated on is another material other than a polymer sheet such as but not limited to paper.

9. A capacitor fabrication process comprising;
a) a continuous polymer sheet that is to be used has at least a portion of the electrical structure of a capacitor, with electrically conductive structures previously deposited on both its surfaces, is fed into one end of a fabrication machine wherein a capacitor structure is to be formed on the sheet's surface; and
b) next the polymer sheet proceeds through a process stage wherein an electrically conductive mixture is deposited by a controlled process on the portions of the electrode structures that are not dielectrically active and where the electrodes exit the capacitor structure to facilitate the making of an external electrical connection to the inner portion of the electrode; and
c) next the polymer sheet proceeds through a drying stage to suitably remove any solvents that remain in the electrically conductive mixture; and
d) next the polymer sheet proceeds through a process stage wherein a dielectric layer is selectively deposited on the polymer sheet by a controlled process to form the dielectric of a capacitor; and
e) then the polymer sheet proceeds through a drying stage to suitably remove any solvents that remain in the electrically conductive mixture and dielectric layers; and
f) next the polymer sheet proceeds through a process stage wherein it is cut into sheets of a predetermined size; and
g) the cut polymer sheets proceeds to a process stage wherein they are stacked on top of each other; and
h) when a stack of cut polymer sheets reach a predetermined height, thus forming a capacitor, the stack is moved from the stacking area and a new stack of cut polymer sheets is started; and
i) then the capacitor is moved to the next stage of processing where its electrical terminations are modified; and
j) the capacitor is moved to the next stage of processing where it is subjected to a predetermine profile of pressure, temperature and electrical stimulus to alter the capacitor's mechanical and electrical properties to comply with a preset specification; and
k) then the capacitor is visually inspected and electrically tested.

10. As in claim 9 except that during the stacking process a number or capacitors are simultaneously fabricated and the process is modified such that after the completion of the finished stack often, but not limited to this specific stage, subdivided into individual capacitors prior to the completion of their electrical terminations and then the individual capacitors proceed to the remaining process stages in a normal manner.

11. As in claim 9 except the process is modified such that at least one additional continuous polymer sheet, with at least a portion of the electrical structure of a capacitor, with electrically conductive structures previously deposited on both its surfaces, is fed into the fabrication machine after the electrical conductive and dielectric layers previously deposited have suitably dried, thus forming another layer of the capacitor structure whereupon additional electrical and dielectric layers are deposited in a controlled process similar in manner to the previous process stages to form a layered structure which is then suitably dried and subjected to the remaining process stages.

12. As in claim 9 wherein the controlled deposition process used for the electrically conductive and dielectric layers is one of but not limited to a printing process such as silk screen, transfer, offset, industrial ink jet, spraying.

13. As in claim 9 wherein at least a portion of the electrode layer used in the fabrication process is self-healing such that should a portion of dielectric layer form an electrical short circuit it is disconnected from the rest of the capacitor structure.

14. As in claim 9 wherein at least a portion of the electrode layer used in the fabrication process is corrosion resistant to prevent any chemically active free radicals that are generated throughout the life of the capacitor from eroding the capacitor electrode.

15. As in claim 9 wherein a portion of the electrode structure that is in areas that are dielectrically active are printed using an electrically conductive material such as but not limited to conductive ink.

16. As in claim 9 wherein the structure that has been fabricated has been modified such that the dielectric layers deposited have a large mechanical response to the application of an external electric field in such a way that it is suitable for use as a sonic transducer for the production of mechanical vibrations.

17. As in claim 9 wherein the structure that has been fabricated has been modified such that the dielectric layers deposited have a large mechanical response to the application of an external electric field in such a way that it is suitable for use as a mechanical actuator.

18. As in claim 9 wherein the capacitor stack, with at least one active capacitor layer, is embedded as a portion of or a complete layer in a printed circuit board.

19. As in claim 9 except the sheet that the capacitor structure is fabricated on is another material other than a polymer sheet such as but not limited to paper.

20. As in claim 9 wherein the structure that was formed is a stack of ceramic or glass capacitor green sheets and after its construction the stack assembly is processed accordingly to burnout, firing and remaining fabrication stages that are used for the manufacture of a multilayer ceramic or glass capacitor.

21. As in claim 20 wherein the electrode structure used in the fabrication of the ceramic or glass capacitor is self-healing.

22. A capacitor fabrication process comprising;
a) a continuous polymer sheet that is to be used as at least a portion of the electrical structure of a capacitor, with electrically conductive structures previously deposited on both its surfaces, is fed into one end of a fabrication machine wherein a capacitor structure is to be formed on the sheet's surface; and
b) next the polymer sheet proceeds through a process stage wherein an electrically conductive mixture is deposited by a controlled process on the portions of the electrode structures that are not dielectrically active and where the electrodes exit the capacitor structure to facilitate the making of an external electrical connection to the inner portion of the electrode; and
c) next the polymer sheet proceeds through a drying stage to suitably remove any solvents that remain in the electrically conductive mixture; and
d) next the polymer sheet proceeds through a process stage wherein a dielectric layer is selectively deposited on the polymer sheet by a controlled process to form the dielectric of a capacitor; and
e) next the polymer sheet proceeds through a drying stage to suitably remove any solvents that remain in the electrically conductive mixture and dielectric layer; and
f) next the polymer sheet proceeds through a section of the fabrication machine wherein a number of repeated sections of the machine perform the following sequence of processes, first another electrode layer is transfer printed on top of the previously deposited dielectric and electrically conductive layers, secondly a new electrically conductive mixture is deposited by a controlled process on the portions of the newly printed electrode structures that are not dielectrically active and where the electrodes exit the capacitor structure to facilitate the making of an external electrical connection to the inner portion of the electrode, thirdly the polymer sheet proceeds through a drying stage to suitably remove any solvents that remain in the electrically conductive mixture, fourthly the polymer sheet proceeds through a process stage wherein a dielectric layer is selectively deposited on the polymer sheet by a controlled process to form the dielectric of a capacitor, fifthly the polymer sheet proceeds through a drying stage to suitably remove any solvents that remain in the electrically conductive mixture and dielectric layer and the five processes are repeated until the polymer sheet has passed through the last similar section; and
g) then the polymer sheet proceeds through a stage wherein it is continuously slit into one or more strips of a predetermined width; and
h) the polymer sheet proceeds through a stage wherein the individual strips of the polymer sheet are wound onto bobbins to form axial capacitors; and
i) when a bobbin reaches a predetermined diameter the continuous strip of polymer sheet is disconnected from the full bobbin; and
j) then the individual strip of the polymer sheet is connected to a new bobbin; and
k) a protective wrap or coating is put around the outside of the full bobbin forming a capacitor; and
l) then the capacitor is moved to the next stage of processing where its electrical terminations are modified; and
m) the capacitor is moved to the next stage of processing where it is subjected to a predetermine profile of pressure, temperature and electrical stimulus to alter the capacitor's mechanical and electrical properties to comply with a preset specification; and
n) then the capacitor is visually inspected and electrically tested.

23. As in claim 22 except the polymer sheet is already the required size to fit a single bobbin wherein the slitting process is omitted.

24. As in claim 22 wherein the controlled deposition process used for the electrically conductive and dielectric layers is one of but not limited to a printing process such as silk screen, transfer, offset, industrial ink jet, spraying.

25. As in claim 22 wherein at least a portion of the electrode layer used in the fabrication process is self-healing such that should a portion of dielectric layer form an electrical short circuit it is disconnected from the rest of the capacitor structure.

26. As in claim 22 wherein at least a portion of the electrode layer used in the fabrication process is corrosion resistant to prevent any chemically active free radicals that are generated throughout the life of the capacitor from eroding the capacitor electrode.

27. As in claim 22 wherein a portion of the electrode structure that is in areas that are dielectrically active are printed using an electrically conductive material such as but not limited to conductive ink.

28. As in claim 22 except the sheet that the capacitor structure is fabricated on is another material other than a polymer sheet such as but not limited to paper.

29. A capacitor fabrication process comprising;
a) a continuous polymer sheet that is to be used has at least a portion of the electrical structure of a capacitor, with electrically conductive structures previously deposited on both its surfaces, is fed into one end of a fabrication machine wherein a capacitor structure is to be formed on the sheet's surface; and
b) next the polymer sheet proceeds through a process stage wherein an electrically conductive mixture is deposited by a controlled process on the portions of the electrode structures that are not dielectrically active and where the electrodes exit the capacitor structure to facilitate the making of an external electrical connection to the inner portion of the electrode; and
c) then the polymer sheet proceeds through a drying stage to suitably remove any solvents that remain in the electrically conductive mixture; and
d) next the polymer sheet proceeds through a process stage wherein a dielectric layer is selectively deposited on the polymer sheet by a controlled process to form the dielectric of a capacitor; and
e) then the polymer sheet proceeds through a drying stage to suitably remove any solvents that remain in the electrically conductive mixture and dielectric layers; and
f) next the polymer sheet proceeds through a section of the fabrication machine wherein a number of repeated sections of the machine perform the following sequence of processes, first another electrode layer is transfer printed on top of the previously deposited dielectric and electrically conductive layers, secondly a new electrically conductive mixture is deposited by a controlled process on the portions of the newly printed electrode structures that are not dielectrically active and where the electrodes exit the capacitor structure to facilitate the making of an external electrical connection to the inner portion of the electrode, thirdly the polymer sheet proceeds through a drying stage to suitably remove any solvents that remain in the electrically conductive mixture, fourthly the polymer sheet proceeds through a process stage wherein a dielectric layer is selectively deposited on the polymer sheet by a controlled process to form the dielectric of a capacitor, fifthly the polymer sheet proceeds through a drying stage to suitably remove any solvents that remain in the electrically conductive mixture and dielectric layer and the five processes are repeated until the polymer sheet has passed through the last similar section; and
g) then the polymer sheet proceeds through a process stage wherein it is cut into sheets of a predetermined size; and
h) next the cut polymer sheets proceeds to a process stage wherein they are stacked on top of each other; and
i) when a stack of cut polymer sheets reach a predetermined height, thus forming at least one capacitor, the stack is moved from the stacking area and a new stack of cut polymer sheets is started; and
j) then the capacitor is moved to the next stage of processing where its electrical terminations are modified; and
k) the capacitor is moved to the next stage of processing where it is subjected to a predetermine profile of pressure, temperature and electrical stimulus to alter the capacitor's mechanical and electrical properties to comply with a preset specification; and
l) then the capacitor is visually inspected and electrically tested.

30. As in claim 29 except that during the stacking process a number or capacitors are simultaneously fabricated and the process is modified such that after the completion of the finished stack often, but not limited to this specific stage, subdivided into individual capacitors prior to the completion of their electrical terminations and then the individual capacitors proceed to the remaining process stages in a normal manner.

31. As in claim 29 wherein the controlled deposition process used for the electrically conductive and dielectric layers is one of but not limited to a printing process such as silk screen, transfer, offset, industrial ink jet, spraying.

32. As in claim 29 wherein at least a portion of the electrode layer used in the fabrication process is self-healing such that should a portion of dielectric layer form an electrical short circuit it is disconnected from the rest of the capacitor structure.

33. As in claim 29 wherein at least a portion of the electrode layer used in the fabrication process is corrosion resistant to prevent any chemically active free radicals that are generated throughout the life of the capacitor from eroding the capacitor electrode.

34. As in claim 29 wherein a portion of the electrode structure that is in areas that are dielectrically active are printed using an electrically conductive material such as but not limited to conductive ink.

35. As in claim 29 wherein the structure that has been fabricated has been modified such that the dielectric layers deposited have a large mechanical response to the application of an external electric field in such a way that it is suitable for use as a sonic transducer for the production of mechanical vibrations.

36. As in claim 29 wherein the structure that has been fabricated has been modified such that the dielectric layers deposited have a large mechanical response to the application of an external electric field in such a way that it is suitable for use as a mechanical actuator.

37. As in claim 29 wherein the capacitor stack, with at least one active capacitor layer, is embedded as a portion of or a complete layer in a printed circuit board.

38. As in claim 29 except the sheet that the capacitor structure is fabricated on is another material other than a polymer sheet such as but not limited to paper.

39. As in claim 29 wherein the structure that was formed is a stack of ceramic or glass capacitor green sheets and after its construction the stack assembly is processed accordingly to burnout, firing and remaining fabrication stages that are used for the manufacture of a multilayer ceramic or glass capacitor.

40. As in claim 39 wherein the electrode structure used in the fabrication of the ceramic or glass capacitor is self-healing.

41. A capacitor fabrication process comprising;
a) a polymer sheet, upon which at least one capacitor structure is to be fabricated, is wound onto a rotary wheel until the desired thickness is reached; and
b) next around its axis a process wheel is rotated, whereupon at least one section of the machine performs the following sequence of processes, first an electrode layer is transfer printed on top of the previously layer, secondly an electrically conductive mixture is deposited by a controlled process on the portions of the newly printed electrode structures that are not dielectrically active and where the electrodes exit the capacitor structure to facilitate the making of an external electrical connection to the inner portion of the electrode, thirdly the wheel rotates through a drying stage to suitably remove any solvents that remain in the electrically conductive mixture, fourthly the wheel rotates through a process stage wherein a dielectric layer is selectively deposited on the wheel by a controlled process to form the dielectric of a capacitor, fifthly the wheel rotates through a drying stage to suitably remove any solvents that remain in the electrically conductive mixture and dielectric layer and the five processes are repeated onto the wheel as it rotates through each stage until a preset number of capacitor layers have been deposited; and
c) next a protective polymer layer is wrapped on top of the newly formed capacitor structures; and
d) then the layered capacitor structure is removed from the process wheel; and
e) the layered capacitor structure is divided into individual capacitors; and
f) then the capacitors are moved to the next stage of processing where their electrical terminations are modified; and
g) the capacitors are moved to the next stage of processing where they are subjected to a predetermine profile of pressure, temperature and electrical stimulus to alter the capacitor's mechanical and electrical properties to comply with a preset specification; and
h) then the capacitors are visually inspected and electrically tested.

42. As in claim 41 wherein the controlled deposition process used for the electrically conductive and dielectric layers is one of but not limited to a printing process such as silk screen, transfer, offset, industrial ink jet, spraying.

43. As in claim 41 wherein at least a portion of the electrode layer used in the fabrication process is self-healing such that should a portion of dielectric layer form an electrical short circuit it is disconnected from the rest of the capacitor structure.

44. As in claim 41 wherein at least a portion of the electrode layer used in the fabrication process is corrosion resistant to prevent any chemically active free radicals that are generated throughout the life of the capacitor from eroding the capacitor electrode.

45. As in claim 41 wherein a portion of the electrode structure that is in areas that are dielectrically active are printed using an electrically conductive material such as but not limited to conductive ink.

46. As in claim 41 wherein the structure that has been fabricated has been modified such that the dielectric layers deposited have a large mechanical response to the application of an external electric field in such a way that it is suitable for use as a sonic transducer for the production of mechanical vibrations.

47. As in claim 41 wherein the structure that has been fabricated has been modified such that the dielectric layers deposited have a large mechanical response to the application of an external electric field in such a way that it is suitable for use as a mechanical actuator.

48. As in claim 41 wherein the capacitor stack, with at least one active capacitor layer, is embedded as a portion of or a complete layer in a printed circuit board.

49. As in claim 41 except the sheet that the capacitor structure is fabricated on is another material other than a polymer sheet such as but not limited to paper.

50. As in claim 41 wherein the structure that was formed is a stack of ceramic or glass capacitor green sheets and after its construction the stack assembly is processed accordingly to burnout, firing and remaining fabrication stages that are used for the manufacture of a multilayer ceramic or glass capacitor.

51. As in claim 50 wherein the electrode structure used in the fabrication of the ceramic or glass capacitor is self-healing.

52. A capacitor fabrication process comprising;
a) a polymer sheet, upon which at least one capacitor structure is to be fabricated, is loaded into the capacitor fabrication machine; and
b) the sheet is moved backward and forward through the section of the machine which performs the following sequence of processes, first an electrode layer is transfer printed on top of the previously layer, secondly an electrically conductive mixture is deposited by a controlled process on the portions of the newly printed electrode structures that are not dielectrically active and where the electrodes exit the capacitor structure to facilitate the making of an external electrical connection to the inner portion of the electrode, thirdly the sheet goes through a drying stage to suitably remove any solvents that remain in the electrically conductive mixture, fourthly the sheet passes through a process stage wherein a dielectric layer is selectively deposited on the sheet by a controlled process to form the dielectric of a capacitor, fifthly the sheet is passed through a drying stage to suitably remove any solvents that remain in the electrically conductive mixture and dielectric layer and the five processes are repeated onto the sheet as it is moved forward and backward through each stage until a preset number of capacitor layers have been deposited; and
c) next a protective polymer layer is placed on top of the newly formed capacitor structures; and
d) then the sheet is divided into individual capacitors; and
e) then the capacitors are moved to the next stage of processing where their electrical terminations are modified; and
f) then the capacitors are moved to the next stage of processing where they are subjected to a predetermine profile of pressure, temperature and electrical stimulus to alter the capacitor's mechanical and electrical properties to comply with a preset specification; and
g) then the capacitors are visually inspected and electrically tested.

53. As in claim 52 wherein the controlled deposition process used for the electrically conductive and dielectric layers is one of but not limited to a printing process such as silk screen, transfer, offset, industrial ink jet, spraying.

54. As in claim 52 wherein at least a portion of the electrode layer used in the fabrication process is self-healing such that should a portion of dielectric layer form an electrical short circuit it is disconnected from the rest of the capacitor structure.

55. As in claim 52 wherein at least a portion of the electrode layer used in the fabrication process is corrosion resistant to prevent any chemically active free radicals that are generated throughout the life of the capacitor from eroding the capacitor electrode.

56. As in claim 52 wherein a portion of the electrode structure that is in areas that are dielectrically active are printed using an electrically conductive material such as but not limited to conductive ink.

57. As in claim 52 wherein the structure that has been fabricated has been modified such that the dielectric layers deposited have a large mechanical response to the application of an external electric field in such a way that it is suitable for use as a sonic transducer for the production of mechanical vibrations.

58. As in claim 52 wherein the structure that has been fabricated has been modified such that the dielectric layers deposited have a large mechanical response to the application of an external electric field in such a way that it is suitable for use as a mechanical actuator.

59. As in claim 52 wherein the capacitor stack, with at least one active capacitor layer, is embedded as a portion of or a complete layer in a printed circuit board.

60. As in claim 52 except the sheet that the capacitor structure is fabricated on is another material other than a polymer sheet such as but not limited to paper.

61. As in claim 52 wherein the structure that was formed is a stack of ceramic or glass capacitor green sheets and after its construction the stack assembly is processed accordingly to burnout, firing and remaining fabrication stages that are used for the manufacture of a multilayer ceramic or glass capacitor.

62. As in claim 61 wherein the electrode structure used in the fabrication of the ceramic or glass capacitor is self-healing.
